(19) United States
(12) Patent Application Publication
(10) Pub. No.: US 2025/0081964 A1
(43) Pub. Date: Mar. 13, 2025

(54) METHOD OF USING/APPLYING A KERATIN HYDROLYSIS PEPTIDE SOLUTION UPON COFFEE PLANTS TO PROMOTE RIPENING, INCREASE REDUCING SUGAR CONTENT AND REDUCE CHLOROGENIC ACID CONENT

(71) Applicant: CH Biotech R&D Co., Ltd., Nantou City (TW)

(72) Inventors: Iou-Zen CHEN, Taipei (TW); Chuan LEE, Taichung (TW); Pei-Chun LIAO, New Taipei City (TW); Yu-Yi WU, Taichung (TW); Feng-Ju HO, Pingtung (TW); Tsai-Yu YANG, Taichung (TW); Cyun-Jhe YAN, Taoyuan (TW); Yu-Lun LIU, Taichung (TW)

(73) Assignee: CH Biotech R&D Co., Ltd., Nantou City (TW)

(21) Appl. No.: 18/536,214

(22) Filed: Dec. 11, 2023

(30) Foreign Application Priority Data
Sep. 13, 2023 (TW) 112134953
Sep. 22, 2023 (TW) 112136371
Sep. 28, 2023 (TW) 112137542

(51) Int. Cl. A01N 37/44; A01P 21/00

(52) U.S. Cl. CPC A01N 37/44; A01P 21/00

(57) ABSTRACT

Present invention teaches the method of using a keratin hydrolysis peptide (“KHP”) solution to accelerate the ripening and color change of the coffee fruits, to increase the reducing sugar content, and to decrease the chlorogenic acid content in coffee beans. By selectively choosing specific weights of feathers and water, and treating the mixture, though one embodiment does not have water mixed in, to a high-temperature high-pressure hydrolysis process, the resulting solution is confirmed to contain at least 253 peptides and then applied to the leaf surface of coffee plants at different growth stages. Optionally, the KHP solution can be diluted by water, as taught in the specification, before applying to the leaf surface of the coffee plants.

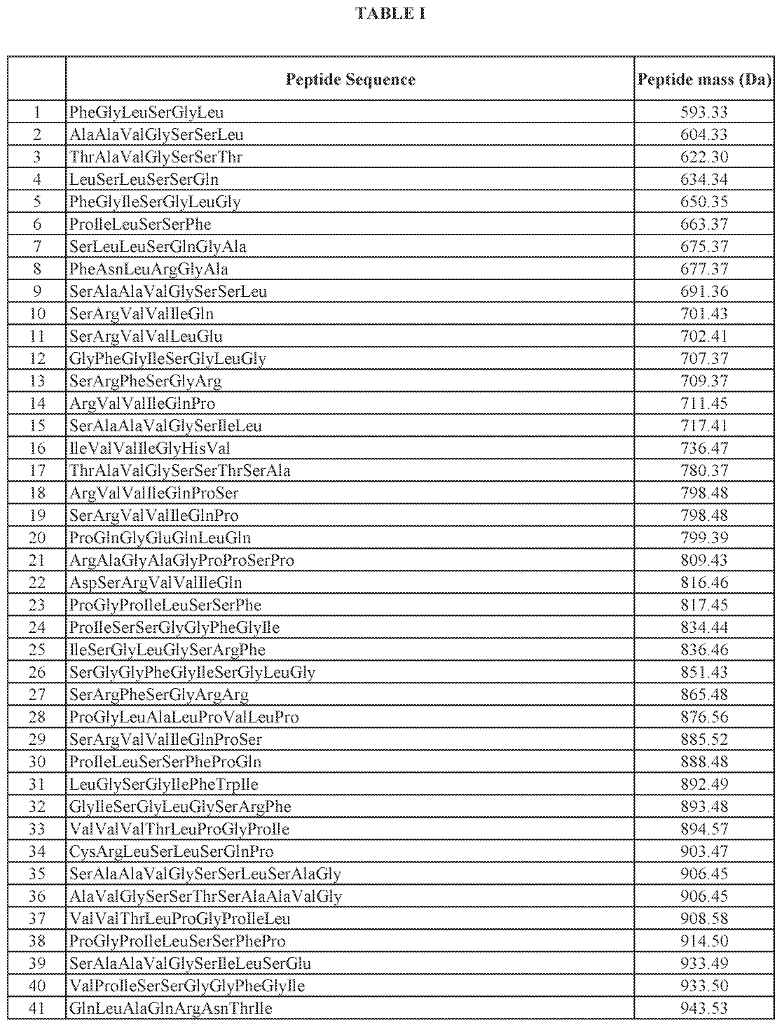

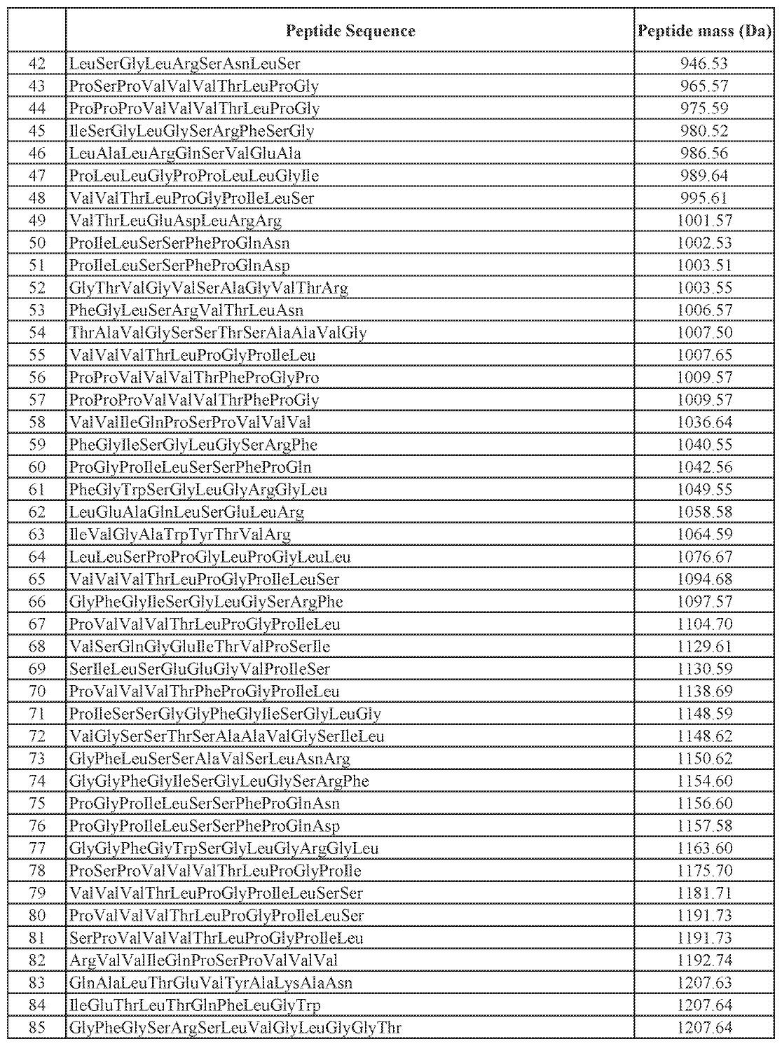

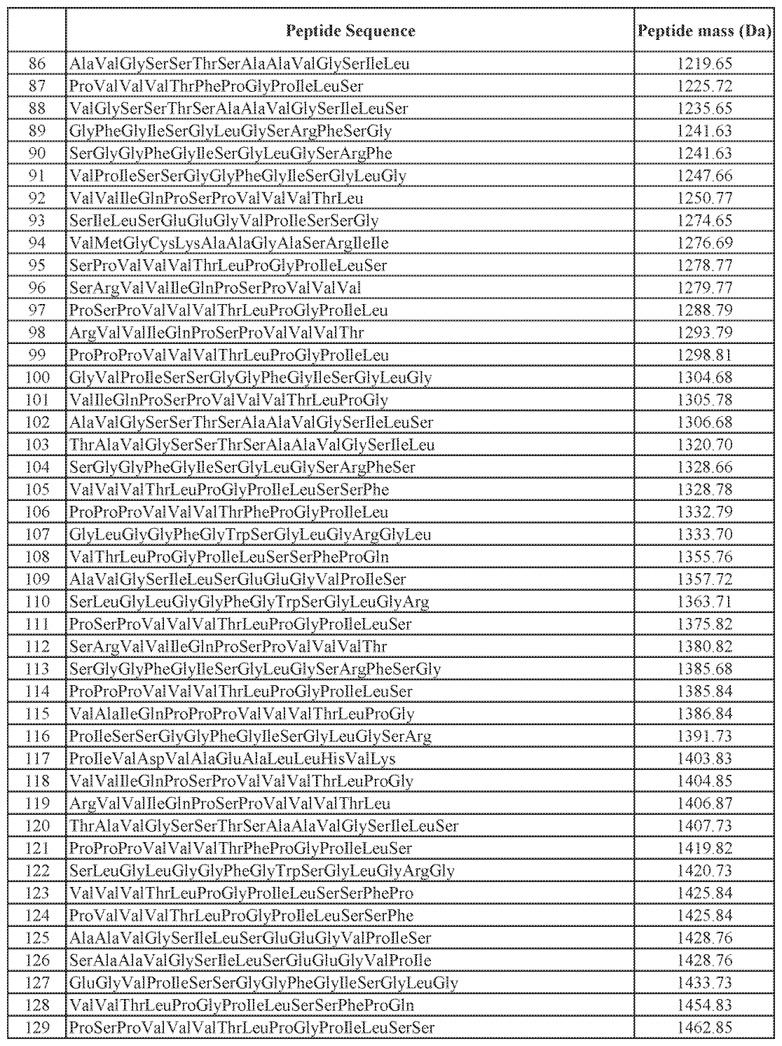

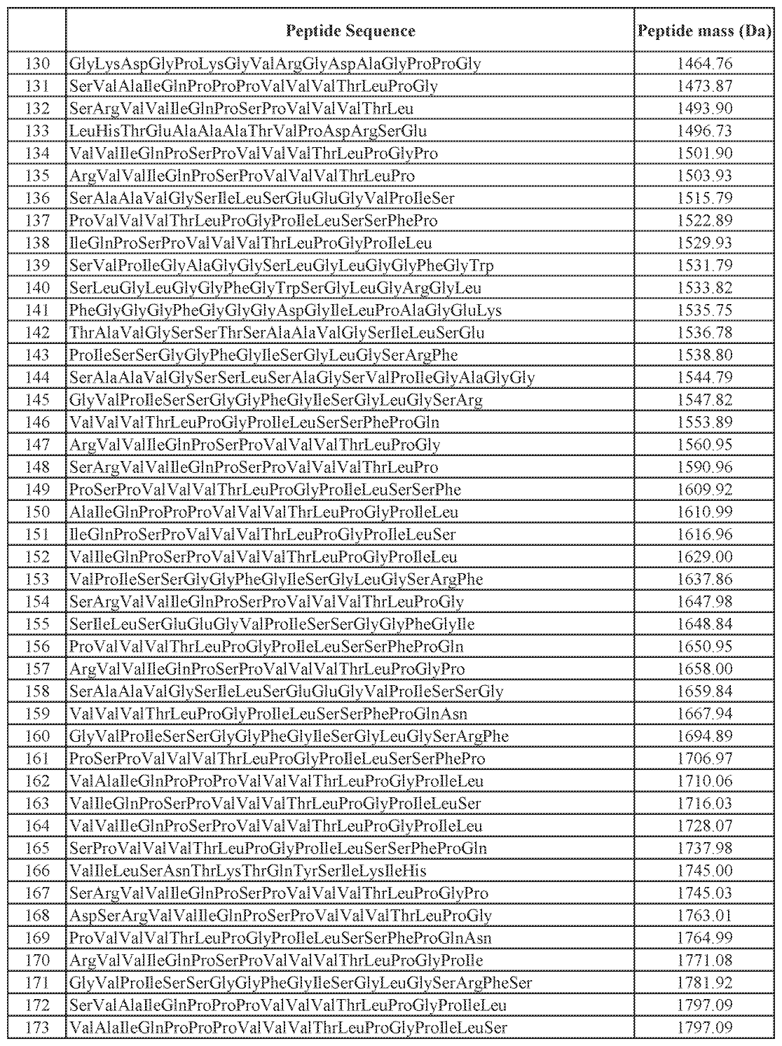

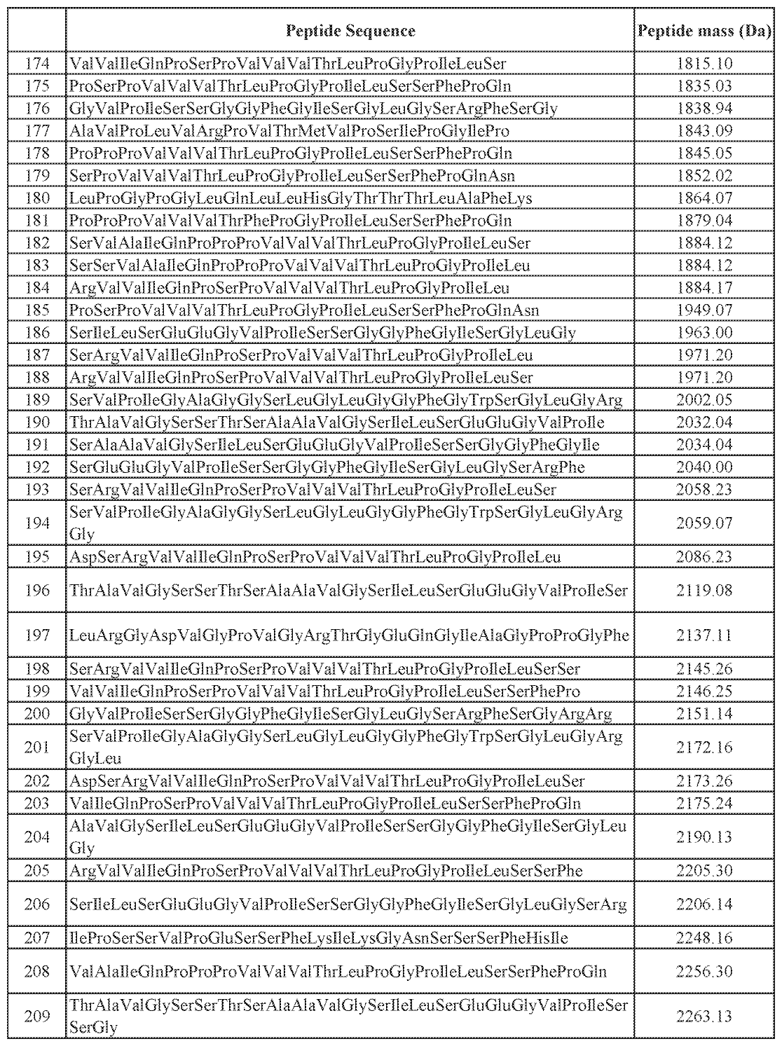

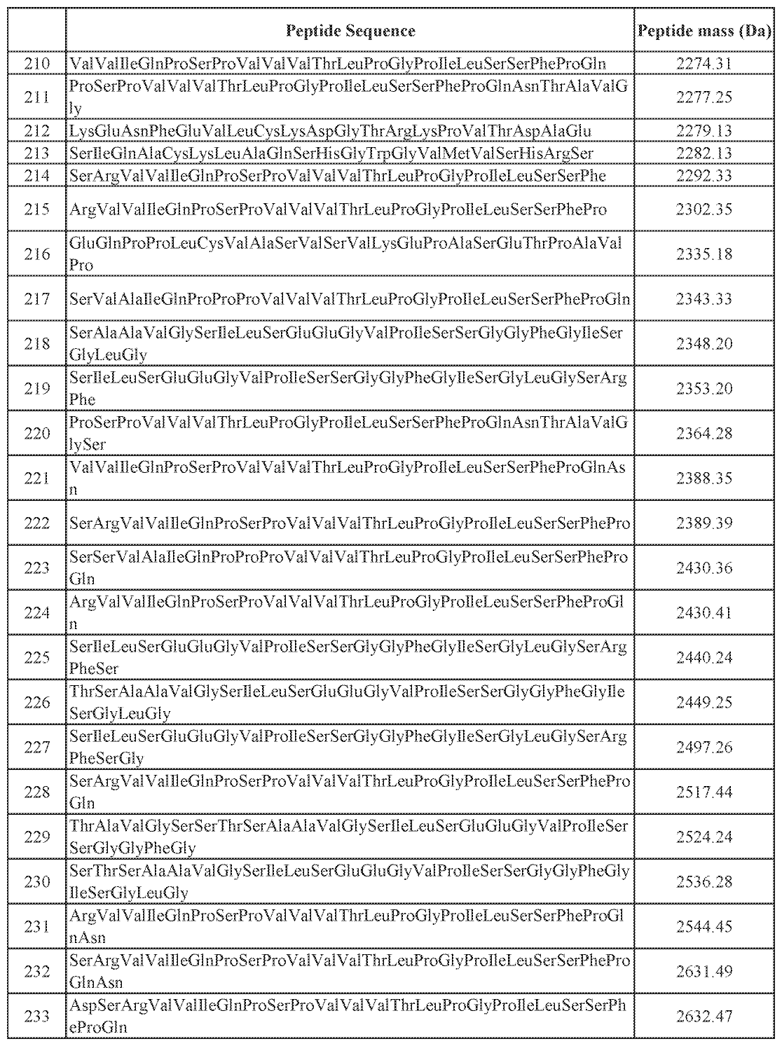

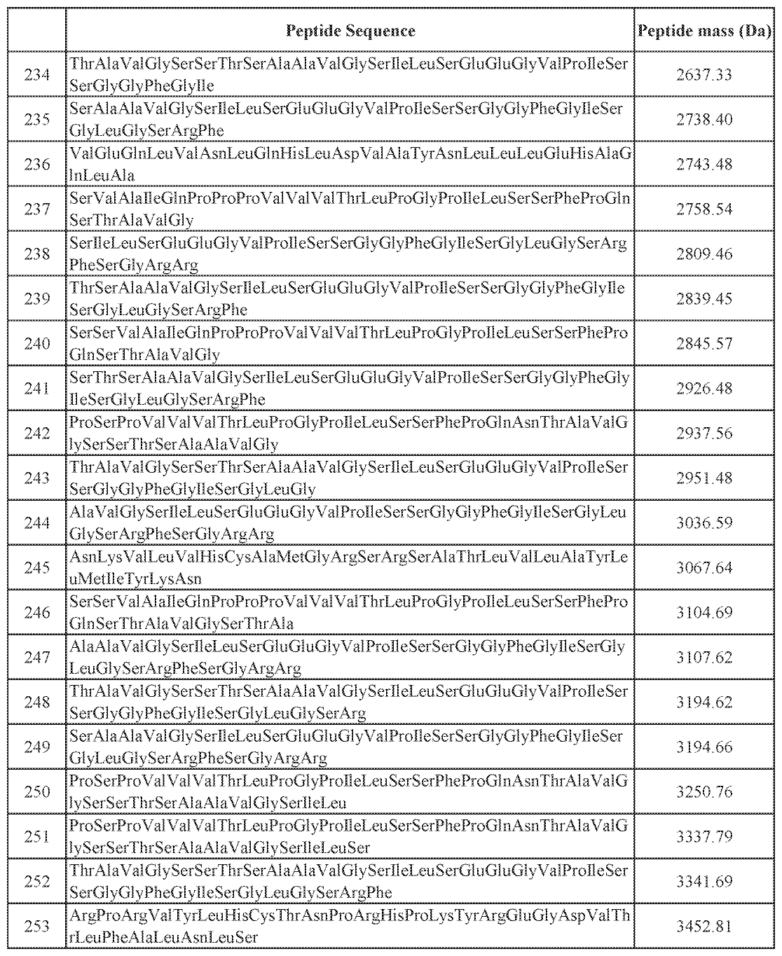

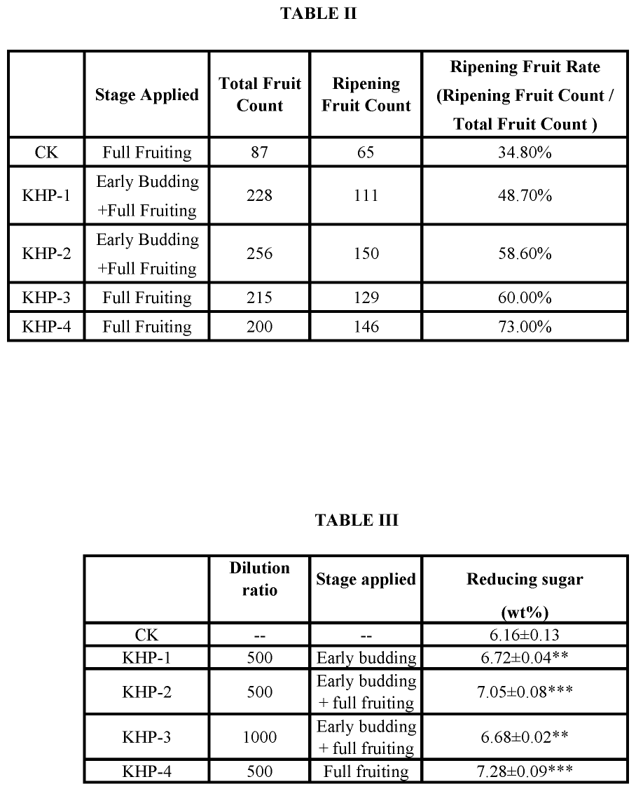

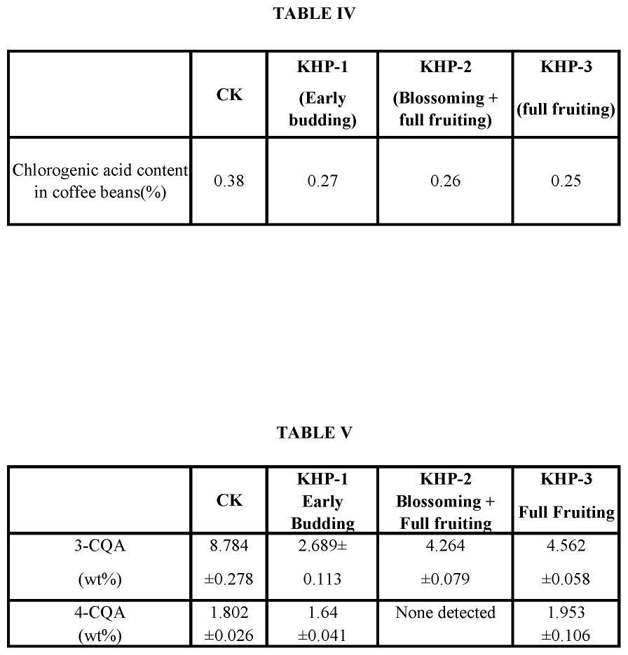

### PRIORITY CLAIM TO FOREIGN APPLICATION

Applicant hereby makes priority claim to Taiwan application, number 112134953, having the Taiwan filing date of Sep. 13, 2023, Taiwan application, number 112136371, having the Taiwan filing date of Sep. 22, 2023 and Taiwan application, number 112137542, having the Taiwan filing date of Sep. 28, 2023.

### BACKGROUND OF THE INVENTION

Present invention disclosed and claimed the method and application of a keratin hydrolysis peptide (“KHP”) solution to accelerate the coffee's ripening/color change, to increase the reducing sugar content and to decrease the chlorogenic acid content.

The KHP solution is made by a hydrolysis process using feathers and water, with one version of the solution using feathers only, via a high-temperature and high-pressure process, resulting in a solution that has many beneficial applications in the fields of horticulture, agriculture and potentially other farming businesses.

Hydrolyzed keratin has long been used to strengthen hairs, reduce breakage, and minimize damages. Some form of chemical process is used to break down the large protein molecule of the hydrolyzed keratin so that it can penetrate the hair cuticles and provide the nutrients to the needed cells. Hydrolyzed keratin is also known to have beneficial uses for agricultural purposes.

Coffee planting, harvesting and drinking is one of the most important economy activities dating back hundreds of years in many places of the world. Many countries, such as Brazile, Colombia and Vietnam, among others, heavily rely on the export of coffee to boost their GDPs. Better coffee fruiting weight and yield will certain add to financial benefits of the farmers in the coffee-exporting countries, as well as consumers worldwide.

Depending on different growth environments, the fruiting of coffee beans starts roughly 50 days after flowering. The color change then ensues, for a period of 30 days. The overall time needed for coffee bean's initial fruiting, in green color, to maturity of red color takes about 70 days.

Given all the adverse factors such as the weather changes, potential diseases, labor uncertainty issues, it is very important that coffee farmers can have sufficient control of the maturity timing for harvest, to maximize the economy of the coffee farming.

It is known that the existence of certain reducing sugars in coffee beans will add to the desired flavor and aroma of coffee, causing such coffee to be among the highest value desired by many consumers. Reducing sugars include sugars of the aldehyde group, ketones group, glucose, fructose, or polysaccharides composed thereof. The reducing sugars take up roughly 50% of coffee beans' weight and are the primary source of the aroma when the coffee beans are being baked as the beans are subject to caramelization reaction and/or Maillard reaction.

The reducing sugars, via the reactions stated above, then release certain aromatic smells that are reminiscent of caramel, syrup, and chocolate, inherently pleasing to many people. As such, many attempts have been made to enhance/increase the reducing sugars in coffee beans.

It is also known that chlorogenic acid (CGA), as an all-inclusive phenolic acid that can be found in coffee, will produce a bitter taste during the baking process, as it was broken down into quinic acid and caffeic acid. Certain 3-caffeoylquinic acid (3-CQA) and 4-caffeoylquinic acid (4-CQA) also tend to be released from the CGA during the baking process that are known to add to the bitterness. As such, there are efforts within the industry to try to decrease the content of chlorogenic acid, 3-CQA and 4-CQA, so as to enhance the sweetness and lessen the bitterness in the coffee beans.

It is well known that feathers of domestic birds/fowls contain 85-91% keratin, 13-15% organic nitrogen,1.6-2% organic sulfur, as well as other materials. The high keratin content has drawn many prior researches that work to break down, by enzyme, chemical agents, or fermentation process, into peptides, amino acids and other smaller molecules that can be used for animal feeds, plant fertilizers, and cultivation bases.

Around 2019, Nurdiawati, et al, came up with a hydrolysis process, by mixing feathers and water (generally at a rate of 1:3) for treatment of a high-temperature and high-pressure (setting of 160° C., 6.1 kg/cm², or setting of 180° C. and 9.2 kg/cm² for a duration of 30 minutes) that obtained a solution. The keratin solution is then mixed with other fertilizers containing nitrogen, potassium and other minerals before applying to plants.

The keratin hydrolysis solution is shown to boost the growth of Pogostemon cablin and Vigna radiata, as reported by Nurdiawati et al., 2019.

Under the aegis of CH Biotech, inventors of present application experimented and worked on the method of employing a high-temperature and high-pressure hydrolysis process, materially different from Nurdiawati, to break down the keratin in feathers, and to form a hydrolyzed peptide (“KHP”) solution that can be applied to coffee plants, suitable for increasing the fruiting weight and yield, increasing the more cost-effective coffee farming and harvesting.

### SUMMARY OF THE INVENTION

The embodiment of the method of using a keratin hydrolysis peptide (KHP) solution comprising the steps of:
a. Preparing the KHP solution by preparing and putting 70 kg of feathers whose content is 46% water in a sealed container;
b. hydrolyzing the mixture in the container with a temperature and pressure setting of 180° C. and 13 kg/cm² for a duration of 40 minutes;
c. using the BIOPEP-UWM database to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. applying the solution to the leaf surface of the coffee plant.

The method of using a keratin hydrolysis peptide (KHP) solution stated above is to apply to the leaf surface of the coffee plant at the growth stages of early budding or blossoming.

The method of using a keratin hydrolysis peptide (KHP) solution stated above is to apply to the leaf surface at the full fruiting stage.

The solution stated above can further be diluted by water, by volume at the ratio of 1:200-1,000 for applying to the leaf surface of the coffee plant at the different growth stages.

The inventors, using the solution derived herein, conducted various field tests to confirm the effectiveness of the application to the coffee plants and obtained the desired results as further stated below.

### BRIEF DESCRIPTION OF DRAWINGS

The accompanying drawings, figures and tables, which are incorporated in and constitute a part of this specification, illustrate and exemplify the preferred embodiments of the invention. Together with the description, serve to explain the principles of the invention.

Table I shows the at least 253 peptides and its annotated sequences for the solution generated in accordance with the disclosure of this application.

Table II shows the comparisons of coffee ripening and color change when the KHP solutions, in different dilution ratios and at different growth stages, are applied according to the disclosure of present application.

Table III shows the comparisons of reducing sugar content readings when the KHP solutions, in different dilution ratios and at different growth stages, are applied according to the disclosure of present application.

Table IV shows the comparisons of chlorogenic acid content readings when the KHP solutions are applied, at different growth stages, according to the disclosure of present application.

Table V shows the comparisons of 3-CQA and 4-CQA content readings when the KHP solutions are applied, at different growth stages, according to the disclosure of present application.

### DETAILED DESCRIPTION OF THE INVENTION

A method of using a keratin hydrolysis peptide (KHP) solution to promote the ripening/color change, increase the reducing sugars and decrease the chlorogenic acid of the coffee plant, comprising the steps of:
a. Preparing the KHP solution by preparing and putting 70 kg of feathers whose content is 46% water in a sealed container;
b. hydrolyzing the mixture in the container with a temperature and pressure setting of 180° C. and 13 kg/cm² for a duration of 40 minutes;
c. using the BIOPEP-UWM database to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. applying the solution to the leaf surface of the coffee plant.

The method of using a keratin hydrolysis peptide (KHP) solution stated above where the solution to applied to the leaf surface of the coffee plant at the growth stages of early budding, blossoming or full fruiting.

The method of using a KHP solution stated above where the solution is diluted with water by volume at the ratio of 1:200-1,000 and is sprayed to the coffee leaves' surface at the growth stages of early budding, blossoming or full fruiting.

The inventors specifically implemented the dilution ratios of 1:250, 1:500 and 1:1000 for spraying to the coffee leaves' surface at the growth stages stated above.

In the research and experiment to prove the efficacy of the method as taught herein, the inventors used a species of Coffea arabica, SL34, which is a common plant species in Taiwan. The planting field was set at elevation of between 800 and 850 meters above sea level.

A check group of Coffea arabica without applying the KHP solution is noted as CK.

For field tests on ripening and color change when applying KHP solutions, four comparison groups are noted as KHP-1, KHP-2, KHP-3, and KHP-4, depending on the solutions, dilution ratios and growth stages applied. The results are shown in Table II.

For field tests on the reducing sugar content, four comparison groups are noted as KHP-1, KHP-2, KHP-3, and KHP-4, depending on the solutions, dilution ratios and growth stages applied. The results are shown in Table III.

For field tests on the chlorogenic acid content, and the 3-CQA and 4-CQA content, three comparison groups are noted as KHP-1, KHP-2 and KHP-3, depending on growth stages applied. The results are shown in Tables IV and V.

To confirm the effectiveness of the KHP solutions on coffee ripening and color change, four (4) groups of coffee plants are applied with KHP. KHP-1 and KHP-3 are diluted with water at 500 times by volume; KHP-2 and KHP-4 are diluted with water at 250 times by volume.

The field tests are conducted by applying 1,000 liters of the solution per metric acre of coffee plants, whereas the check group (CK) is sprayed with same amount of water, without the KHP solutions.

As shown in Table II, the four comparison groups' leaf surfaces are sprayed with the solutions at different growth stages as shown in the table. At harvest time, three (3) branches from each group are taken to measure the total fruit counts and the ripening/color change performance.

As shown, any of the four comparison groups shows substantial improvement in both total fruit count and the ripening/color change numbers, with the check (CK) group showing the worst number of 187 total fruit count and ripening fruit count of 65.

For the four (4) groups of KHP solution tests on reducing sugar content, the dilution ratios are noted in Table III.

As shown in Table III, the check (CK) group has the worst reducing sugar content and each of the KHP solution group performs much better than the check group. Notably, the KHP-4 group, with 500 times dilution ratio, has the highest reducing sugar content. Finally, for the chlorogenic acid, 3-CQA and 4-CQA contents that are related to the

bitterness of the coffee taste (less sweetness, put another way), the results are shown in Tables IV and V, where the three comparison groups use the same KHP solution diluted at the same 250 times ratio; they differ only at stage(s) of application.

In Table IV, the KHP-3 group received spraying at the full fruiting stage and obtained the best (lowest) CGA reading of 0.25, compared to the check (CK) group of 0.38.

In Table V, the 3-CQA content in any of the three comparison groups is lower than the check group. The 4-CQA content is not detected in the KHP-2 group where the application of the KHP solution was applied at blossoming and full fruiting stages.

Overall, the research and experiment show that the method of making the KHP solutions and the application of the solution to the coffee plants at the growth stages as disclosed substantially increased the desired ripening and color change and the reducing sugar content, while the chlorogenic acid (along with the 3-CQA and 4-CQA) content is decreased, making the coffee more flavorful, sweet and tasty and less bitter.

While the disclosure herein gave limited teachings and embodiment examples, it should be noted that the description and disclosure made herein illustrated the preferred embodiments of the invention and are not meant to limit the scope of the applicant's rights. Variations and alterations may be employed for yet additional embodiments without departing from the scope of the invention herein.

1. A method of using a keratin hydrolysis peptide (KHP) solution to promote the ripening, increase the reducing sugars, and decrease the chlorogenic acid of the coffee plant, comprising the steps of:
a. Preparing the KHP solution by preparing and putting 70 kg of feathers whose content is 46% water in a sealed container;
b. hydrolyzing the mixture in the container with a temperature and pressure setting of 180° C. and 13 kg/cm² for a duration of 40 minutes;
c. using the BIOPEP-UWM database to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. applying the solution to the leaf surface of the coffee plant.

2. The method of using a keratin hydrolysis peptide (KHP) solution of claim 1 where the solution to applied to the leaf surface of the coffee plant at the growth stages of early budding, blossoming or full fruiting.

3. The method of using a KHP solution of claim 1 where the solution is diluted with water by volume at the ratio of 1:200-1,000 and is sprayed to the coffee leaves' surface at the growth stages of early budding, blossoming or full fruiting.

4. The method of using a KHP solution of claim 3 where the solution is diluted with water by volume at the ratio of 1:250 and is sprayed to the coffee leaves' surface at the growth stages of early budding, blossoming or full fruiting.

5. The method of using a KHP solution of claim 3 where the solution is diluted with water by volume at the ratio of 1:500 and is sprayed to the coffee leaves' surface at the growth stages of early budding, blossoming or full fruiting.

6. The method of using a KHP solution of claim 3 where the solution is diluted with water by volume at the ratio of 1:1000 and is sprayed to the coffee leaves' surface at the growth stages of early budding, blossoming or full fruiting.
